(19) United States
(12) Patent Application Publication
(10) Pub. No.: US 2010/0038506 A1
(43) Pub. Date: Feb. 18, 2010

(54) Self-Connectors

(76) Inventors: Lloyd Herbert King, JR., Chesterfield, MO (US); James C. Keeven, O'Fallon, MO (US)

Correspondence Address: Carl L. Johnson;Jacobson and Johnson, Suite 285, One West Water Street, St. Paul, MN, 55107-2080, US

(21) Appl. No.: 12/228,828

(22) Filed: Aug. 14, 2008

(51) Int. Cl. G09F 7/22

(52) U.S. Cl. 248/230.7; 248/302; 248/231.81

(57) ABSTRACT

A self-connector for attachment and detachment with the self connector comprising an rigid elongated member in a curved condition yet resilient with sufficient flexibility that the connectable ends of the self connector can be engaged or disengaged through flexing of the elongated member with the elongated member having sufficient resiliency to enable the connectable ends to be maintained in a connected condition when a circumferential force is applied to the self-connector.

### FIELD OF THE INVENTION

This invention relates generally to connectors and, more specifically, to self-connectors that can be secured to an article though engagement of the ends of the self-connector.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

A variety of connectors for securing articles to each other are available. Some of the connectors include multiple components that are held together by screws or the like. Other connectors, which are one-piece such as split rings have multiple layers that allow one to insert an article on the split ring by sliding the article between the layers of the split ring. Still other connectors use threads on one end and a collar nut on the opposite end to enable one to close the connector by threading the collar nut onto the threaded end of the connector. Still other connectors can be formed into permanent enclosures through deforming the material around an object. Each of such connectors have disadvantages as some are difficult to use, some fail to provide a connector that is low cost, others require moving parts and others can only be engaged and disengaged with the assistance of tools.

### SUMMARY OF THE INVENTION

A one-piece resilient curved self-connector having connectable ends for engaging and disengaging the self-connector to an article. A feature of the self-connector is that the self-connector ends are spreadable to receive an article without the material of the self-connector exceeding its yield point. A feature of the self-connector is integral lateral restraints to prevent the connectable ends from becoming disengaged. In one example the self-connector includes a mount for supporting information signs or hanging screens. In another example the self-connector is useable as a cable tie for holding a bundle of wires. In another example the self-connector maintains wires proximate a pipeline.

### BRIEF DESCRIPTION OF THE DRAWINGS

FIG. 1 is a front view of a self-connector;

FIG. 2 is a perspective view of the mating hooks on the self-connector of FIG. 1;

FIG. 3 is a side view of one of the mating hooks of the self-connector of FIG. 1;

FIG. 4 is an end view of one of the mating hooks of the self-connector of FIG. 1;

FIG. 5 is an end of the other of the mating hooks of the self-connector of FIG. 1;

FIG. 6 is a cross sectional view of the body of the self connector of FIG. 1;

FIG. 7 is a front view of the self-connector of FIG. 1 in an extended condition to engage a pipe;

FIG. 8 is a front view of the self-connector of FIG. 7 engaging a pipe;

FIG. 9 is a front view of the self-connector securing a bundle of wires;

FIG. 10 shows the self-connector supporting a curtain on a curtain rod;

FIG. 11 shows the self connector supporting an information sign;

FIG. 12 shows the self-connector maintaining a wire proximate a pipeline;

FIG. 13 shows a wire holder for securing to a pipe; and

FIG. 14 shows a wire holder with an extended leg for holding a wire in a spaced condition from a pipe.

### DESCRIPTION OF THE PREFERRED EMBODIMENT

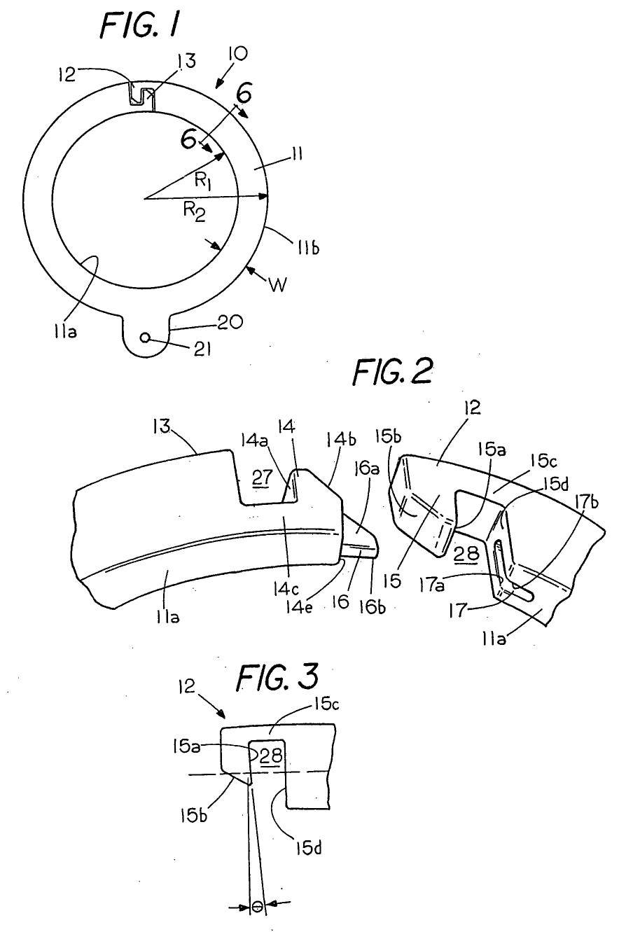

FIG. 1 shows a front view of a resilient self-connector 10 for forming an end-to-end circumferential attachment to itself and to an object. Self-connector 10 comprises a one-piece, elongated, curved, rigid yet, resilient member 11 having a first connectable end 12 and a second connectable end 13. FIG. 1 shows the connectable ends 12 and 13 in the engaged or latched position with the ends 12 and 13 in an end-to-end alignment with each other to form a circular connector with an annular interior surface 11a and FIG. 2 shows the connectable ends 12 and 13 in an unlatched or disengaged condition. Located on first connectable end 13 is a connectable member comprising a hook 14 and located on second connectable end 12 is a connectable member comprising a hook 15 for engagement with hook 14. In the embodiment shown the self-connector has a thickness W with an inner radius R₁ and an outer radius R₂. Although the self-connector is shown as circular the self-connector may take other shapes, for example elliptical. While self-connector 10 can be made from a variety of materials including metals self connector 10 is preferably made from a polymer plastic such as PVC that can by virtue of the elongated curved shape provide a rigid or stiff yet resilient curved member that can be opened and closed without causing the material to exceed its yield strength. That is, if the thickness T of the material and the width of the material W₂ (see FIG. 6) as well as the radius of curvature R can be selected so that a normally rigid material possesses the bending characteristics of an elongated member which allows the material to flex without exceeding the yield strength of the material. A feature of the use of polymer plastics in self-connector 10 is that the self-connector can be used in a wet environment without oxidation causing deterioration of the self-connector. In the example shown in FIG. 1 each of the hooks 12 and 13 have a radial dimension which is equal or less than the width W of the curved member 11 to thereby provide a curved profile where the connectable ends do not extend beyond either the inner annular surface 11a or outer radial peripheral surface 11b of the connector although in certain applications one may desire to have connectable ends where one or both extend beyond the inner or outer radial peripheral surfaces of the connector. In the example of the invention shown in FIG. 1 each of the connectable members 12 and 13 comprise hooks with the hooks facing in opposite directions.

Located on the lower portion of self-connector 10 is an integral mount 20 that contains an opening 21 for engagement of a further article thereto to enable the self-connector 10 to both engage an object within the confines of annular surface 11a and support an article through mount 20, which in the example shown comprises a radial protrusion from annular surface 11b. While an opening 21 is provided for securing a further article thereto other configurations and means may be used for securing a further article thereto, for example a hook or an adhesive may be included as part of mount 20.

While FIG. 1 shows the connectable ends 12 and 13 in the engaged condition FIG. 2 shows an enlarged view of the connector ends in the disengaged condition. Connectable end 13 includes a hook 14 having a shank 14c, an engagement or contact face 14a and a tapered head forming a guide face 14b. In the example shown hook 14 and shank 14c are integrally formed in member 11 to provide a hook head receiving recess 27 bounded by shank 14c and hook engagement face 14a for receiving hook 15 while maintaining the circular shape of the self connector 10. Similarly, connectable end 12 includes a hook 15, which includes a shank 15c, an engagement face 15a and a tapered head forming a guide face 15b. Hook 15 and shank 15c are integrally formed in member 11 to provide a hook head receiving recess 28 bounded by shank 15c and hook engagement face 15a for receiving hook 14 while maintaining the circular shape of the self connector 10. When Hook 15 and hook 14 are in the engaged condition as shown in FIG. 1 they coact to maintain the self-connector 10 in a closed condition by circumferentially restraining hook 14 with respect to hook 15 through engagement of contact face 15a with contact face 14a.

In some cases one may want to inwardly cant the face 15a a few degrees as illustrated in FIG. 3. The use of a canted face 15a and or a canted face 14a can assist in maintaining the hooks 15 and 14 in engagement with each other since circumferential forces on the hooks exerted through elongated member 11 causes the hook contact faces 14a and 15a to slide in a radially direction toward each other as the canted faces 15a and 14a engage each other.

In the example shown the hook 14 and the hook 15 can prevent circumferential and radially separation of the hooks while holding the self-connector around an object. To prevent lateral separation of the connectable ends 12 and 13 there is provide an extension or extension 16 that projects circumferentially outward from head 14e of hook 14. Extension 16 includes sides 16a and 16b that are engageable with a slot 17 located in face 15d. Slot 17 is formed by internal faces 17a and 17b extending from surface 15d. In the connected condition the extension 16 fits into the slot 17 to prevent lateral displacement of the connectable ends 12 and 13.

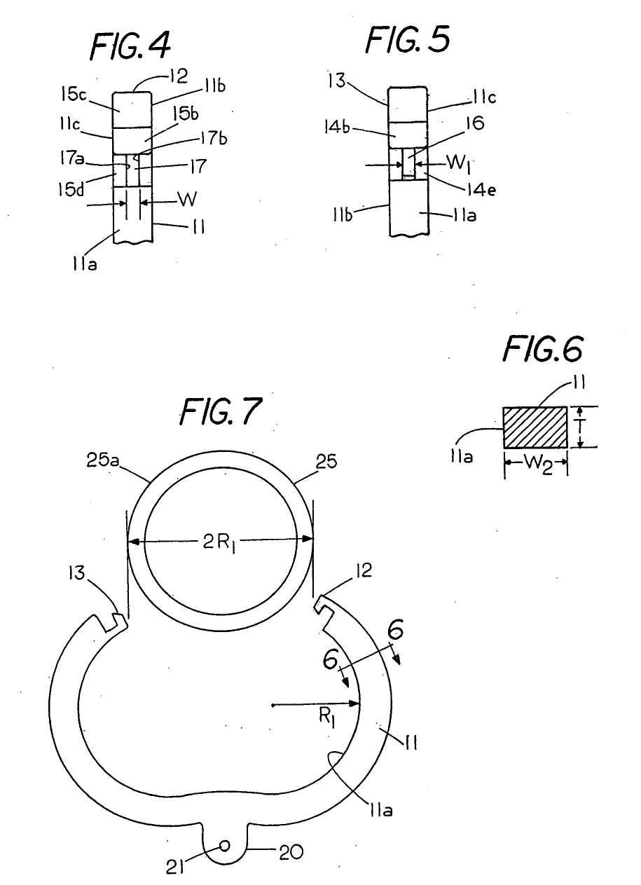

Extension 16 is shown in FIG. 5 as having a width W₁ and similarly slot 17 is shown in FIG. 4 having a width W. The width W₁ of extension 16 is slightly less than the width W of slot 17 and preferably forms a non-interference fit such that extension 16 can be quickly and easily inserted into the slot 17 yet tolerances are sufficiently close so that extension 16 is restrained from lateral movement within slot 17 by sides 17a and 17b. Once extension 16 is in slot 17 the connectable ends 12 and 13 are prevented from lateral disengagement by the coaction of slot 17 and extension 16 as well as radial disengagement by the coaction of hook 14 and hook 15.

FIG. 4 shows, the resilient self-connector 10 with the slot 17 located midway between the lateral face 11b and lateral face 11c with the slot 17 formed by a first slot face 17a and a second slot face 17b. The extension 16, which is shown in FIG. 5, is also located midway between first lateral face 11b and second lateral face 11c to enable the extension 16 to fit into the slot 17 and thus prevent lateral displacement of the connectable ends with respect to each other. While the extension 16 and slot 17 are shown located midway other positions may be used such as off center locations to prevent lateral displacement of the connectable ends. In the example shown the extension 16 and the slot are separate from hook 14 and hook 15. If desired the lateral restrains may be incorporated into other portions of the hook for example the extension and slot may be incorporated into hook face 14a and-hook face 15a.

FIG. 7 illustrates the flexibility of the curved member 11 which allows the ends 12 and 13 to spread apart sufficiently far so that a pipe 25 having an outside diameter of 2R₁ can be inserted therepast and into engagement with the curved member which also has a diameter of 2R₁ without the material exceeding its yield point. By yield point it is meant the point where the bending of the material causes the loss of resiliency of the elongated member.

In the embodiment of FIG. 7 the plastic self-connector 10 comprises a one-piece curved, rigid yet resilient member 11 having a first end with a hook 12 and a second end with a hook 13 for forming the one-piece curved member 11 into a closed loop having a radius of curvature R₁ with one-piece curved member 11 having sufficiently resiliency so that the first end 12 and the second end 13 can be separated to permit insertion of an object therepast with the object having a dimension at least equal to twice the radius of curvature R₁ without exceeding the yield strength of the material of the connector. In the example shown the resiliency of the self-connector is obtained through selection of the thickness and width of the material as well as the distance one wants the ends to spread apart.

As a general rule the thinner the material the greater the ability of the material to bend without yielding. Through either calculation or trial and error the thickness and width can be selected to provide for the proper spreadability of the connectable ends. In the example shown the resilient self-connector 10 comprises a one-piece polymer plastic and the hook 12 is engageable and disengageable with the hook 13 solely through flexing of the rigid yet resilient member 11.

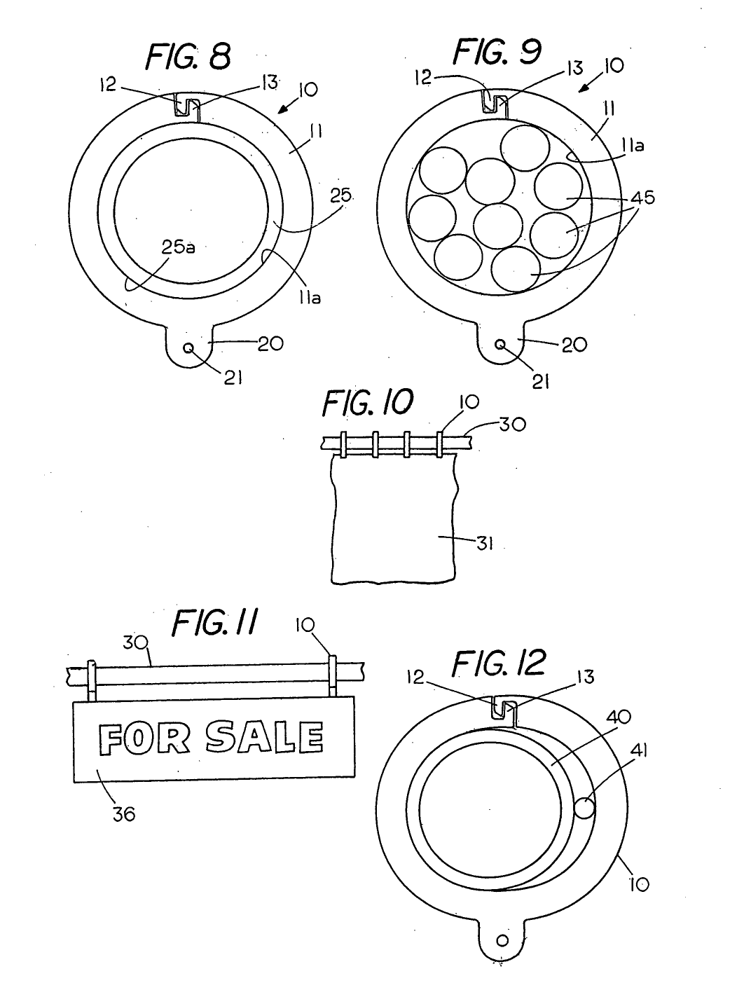

FIG. 8 shows the self-connector 10 located around the outer periphery 25a of pipe 25. Thus a feature of the invention is that the connector ends 12 and 13 can be spread sufficiently far apart so that a pipe having the internal diameter of the connector can be inserted into the connector 10 without causing the material forming the connector to yield thus allowing hooks on the connectable ends to engage each other to circumferentially restrain the ends of the self-connector around an object such as a pipe.

As shown in FIG. 7 and FIG. 8 the self-connector 10 includes a first end with a first hook thereon and a second end with a second hook thereon mateable with the first hook to form an encircling contact about the periphery of a cylindrical object, such as pipe 25, with the first end and the second end spreadable so as to permit the connector to be slid laterally over the periphery of the cylindrical object without exceeding the yield strength of a material forming the self connector.

FIG. 9 shows another use of the self-connector 10 as a cable holder with a group of wires 45 being held proximate each other by the self-connector 10. The use of self-connector 10 as a cable holder is particularly useful when a number of wires are to be retained proximate to each other and then held in position through the mount 20. That is, mount 20 can be secured to a support so that the wires are held proximate the support.

FIG. 10 shows a further use of the self-connector 10 in an inside use such as a shower curtain ring for supporting a shower curtain 31. In this example the self-connector 10 is secured to the shower rod 30 through the connectable ends and the mount is secured-to the shower curtain 31. The use of polymer plastics is useful in applications such as shower curtains since the polymer plastics are readily cleanable and do not corrode in the presences of the moisture from the shower.

FIG. 11 illustrates another use of the self-connector 10, namely an outside use as a connector for displaying information such as a “FOR SALE” sign. A self-connector 10, which is made of polymer plastic may be preferred in such applications since weathering of the self-connector 10 will not cause corrosion and possible discoloration of the self-connector, which could cause discoloration of the information sign.

FIG. 12 shows still another use of the self-connector 10 as a clamp for holding a wire 41 proximate an exterior of pipe 40. Typically, use of self-connector 10 as a clamp may occur in applications employing either underground or above ground pipes where it is desired to maintain a wire conductor proximate the pipe.

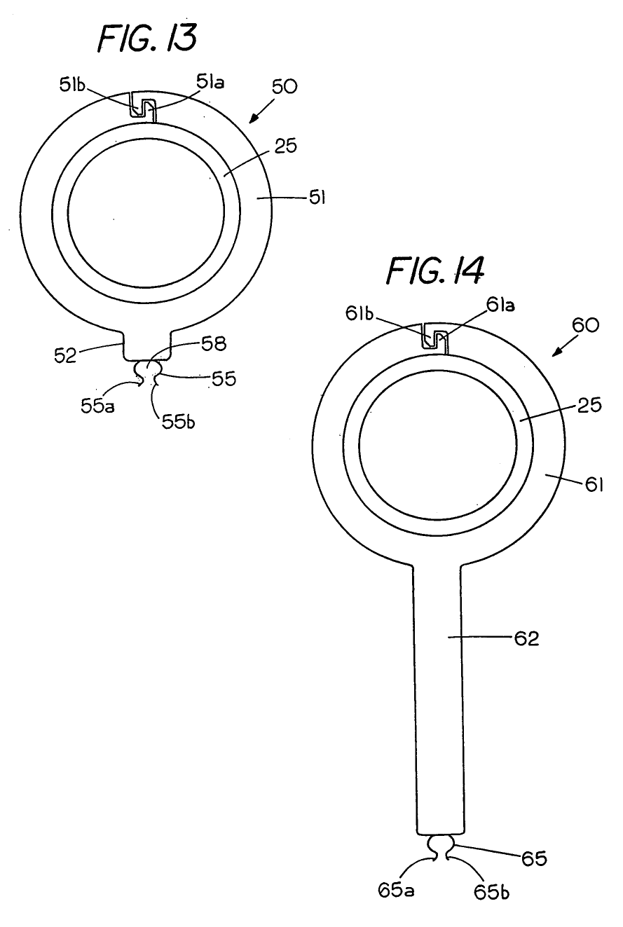

FIG. 13 shows another example of a self-connector 50 for holding a wire proximate a pipe. Self-connector 50 includes a curved elongated member 51 having a hook 51a and 51b for securing the self-connector 50 around a pipe. The mount 52 includes a resilient wire clip 55 having a first extension 55a and a second extension 55b that are secured around a wire 58. In the example shown the wire 58 can be laterally forced between the extensions 55a and 55b, which separate to allow the wire 58 to enter between extensions 55a and 55b so that the wire clip 55 can secure wire 58 therein in a wire engaging condition as shown in FIG. 13.

FIG. 14 shows another example of a self-connector 60 for holding a wire in a spaced condition proximate a pipe. Self-connector 50 includes a curved elongated member 61 having a hook 61a and 61b for securing the self-connector 60 around a pipe 25. The mount 62 extends outward away from the self-connector 60 to hold a wire in a spaced condition from pipe 25. At the end of mount 62 is a resilient wire clip 65 having a first extension 65a and a second extension 65b, which allow lateral insertion and esculent of a wire therebetween.

While a number of uses of the self-connector have been shown and described it should recognized that others may find different uses and applications for the self-connectors described herein. While the self-connector 10 is shown with an integral mount 20 in some applications one may elect not to include a mount in the self-connector. While lateral restraints are shown in some applications the lateral restraints may not be needed.

1. A resilient self-connector for forming an end-to-end circumferential attachment to an object comprising:
a hinge-free resilient yet rigid curved member having a first connectable end and a second connectable end normally extending in an end-to-end alignment with each other;
a first connectable member located on the first connectable end of the resilient member;
a second connectable member located on the second connectable end of the resilient member, said second connectable member engageable with the first connectable member through flexing of said resilient member to circumferentially restrain said first connectable member with respect to said second connectable member;
an extension slot located on said first connectable end proximate said first connectable member; and
an extension located on said second connectable end proximate said second connectable member with said extension engageable with said extension slot to prevent lateral displacement of said first connectable end with respect to said second connectable end to thereby maintain said first connectable member and said second connectable member in engagement with each other.

2. The resilient self-connector of claim 1 wherein the resilient self-connector comprises a one-piece polymer plastic and the second connectable member is engageable and disengageable with the first connectable member solely through flexing of the resilient member.

3. The resilient self-connector of claim 1 wherein each of the connectable members comprises a hook.

4. The resilient self-connector of claim 1 wherein the resilient self-connector has lateral faces and the extension slot is located between the lateral faces of the self-connector.

5. The resilient self-connector of claim 3 wherein the resilient self-connector has lateral faces and each of the hooks extend from face to face of the lateral faces of the self-connector.

6. The resilient self-connector of claim 5 wherein the extension slot for receiving the extension is located between the lateral faces of the self-connector.

7. The resilient self-connector of claim 1 wherein each of the connectable members comprises hooks with the hooks facing in opposite directions.

8. The resilient self-connector of claim 7 wherein each of the hooks includes a canted face.

9. The resilient self-connector of claim 1 wherein the resilient self-connector comprises a circular configuration.

10. The resilient self-connector of claim 1 wherein the resilient self-connector includes an integral mount for supporting an article.

11. The resilient self-connector of claim 1 wherein the resilient self-connector includes an integral mount for supporting an article with a resilient wire clip thereon.

12. The resilient self-connector of claim 1 wherein the resilient self-connector has a first lateral face and a second lateral face with said extension located midway between said first lateral face and said second lateral face and said slot is located midway between said first lateral face and said second lateral face.

13. The resilient self-connector of claim 12 wherein the first lateral face and the second lateral face is substantially parallel to each other.

14. A self-connector comprising:
a hinge-free one-piece curved member having a first end with a first hook and a second end with a second hook for forming the one-piece curved member into a closed loop, said curved member sufficiently resilient so that the first end and the second end can be engaged and disengaged solely by flexing the curved member and without exceeding a yield strength of the curved member;
an extension slot located on said first end proximate said first hook; and
an extension located on said second end proximate said second hook with said extension engageable with said extension slot to prevent lateral displacement of said first end with respect to said second end to thereby maintain said first hook and said second hook in engagement with each other.

15. The self-connector of claim 14 wherein the one-piece curved member comprises a polymer plastic with the second end and the first end spreadable to permit insertion of an object therepast with the object having a dimension at least equal to twice a radius of curvature of the closed loop.

16. The self-connector of claim 14 including an extension on first end and a slot on the second end for receiving the extension to thereby prevent lateral displacement of the first end with respect to the second end.

17. The self-connector of claim 14 including a mount thereon for securing an article thereto, wherein the article is selected from the group consisting of shower curtains and advertising signs.

18. The self-connector of claim 14 wherein the first hook and the second hook are integral to the curved member and the first hook and the second hook each having a radial dimension which is less than a thickness of the curved member.

19. The self-connector of claim 14 wherein the one-piece curved member has a uniform width to enable the one piece curved member to be used as a spacer.

20. The self-connector of claim 15 having the first hook and the second hook are mateable to form an encircling contact about the periphery of a cylindrical object with the first hook and the second hook spreadable so as to permit the connector to be slid laterally around the periphery of the cylindrical object and closeable to bring an inner surface of the self connector into surface engagement with the cylindrical object.

21. The self-connector of claim 15 including a wire clip thereon.

22. A self-connector comprising:
a hinge-free one-piece rigid yet resilient curved member having a first connectable end and securable to a second connectable end, said securement of said first connectable end and said second connectable end forming the rigid yet resilient one-piece curved member into a closed configuration, said rigid yet resilient curved member sufficiently resilient so that the first connectable end and the second connectable end can be engaged and disengaged solely by flexing the curved member and without exceeding a yield strength of the curved member;
an extension slot located proximal said first connectable end; and
an extension located proximal said second connectable end with said extension engageable with said extension slot to prevent lateral displacement of said first connectable end with respect to said second connectable end to thereby maintain said securement of said first connectable end to said second connectable end.
